(19) United States
(12) Patent Application Publication
(10) Pub. No.: US 2003/0127465 A1
(43) Pub. Date: Jul. 10, 2003

(54) Non-contact switch for hot melt adhesive hand applicator

(75) Inventor: Mairi C. MacLean, Hendersonville, TN (US)

Correspondence Address: Steven W. Weinrieb, SCHWARTZ & WEINRIEB, Crystal Plaza One, Suite 1109, 2001 Jefferson Davis Highway, Arlington, VA, 22202, US

(73) Assignee: ILLINOIS TOOL WORKS INC.

(21) Appl. No.: 10/040,390

(22) Filed: Jan. 9, 2002

(51) Int. Cl. B67D 5/62

(52) U.S. Cl. 222/146.5

(57) ABSTRACT

A non-contact switch mechanism for use within a hot melt adhesive applicator gun comprises, for example, a reed switch mechanism rigidly mounted within the handle housing of the applicator gun, and a magnet rigidly mounted upon a rearwardly extending finger portion of the trigger member. Accordingly, when the trigger member is actuated as a result of being depressed or squeezed, the magnet enters the vicinity of the reed switch thereby activating the same so as to effectively convert the same from an OPEN state to a CLOSED state. The switch mechanism controls, for example, a rotary gear pump for supply adhesive material under pressure to the applicator gun, as well as a solenoid air valve for supplying pressurized swirl air to the applicator gun. In lieu of the reed switch mechanism, a proximity switch mechanism, or an optical switch mechanism, may be utilized.

### CROSS-REFERENCE TO RELATED PATENT APPLICATIONS

This patent application is related to U.S. patent application Ser. No. 09/947,476 filed on Sep. 7, 2001 in the name of Christopher D. Bryan et al. and entitled HOT MELT ADHESIVE HAND APPLICATOR.

### FIELD OF THE INVENTION

The present invention relates generally to hot melt adhesive hand applicator guns or implements, and more particularly to a new and improved non-contact switch mechanism incorporated within the handle portion of the applicator gun, and activated by means of the applicator gun trigger member, for operatively controlling, for example, a rotary gear pump by means of which adhesive material is supplied under pressure to the applicator gun, as well as a solenoid air valve by means of which pressurized air can be supplied to the nozzle assembly of the applicator gun in a swirl application mode for interaction with the adhesive material being dispensed.

### BACKGROUND OF THE INVENTION

As disclosed within the aforenoted patent application, hot melt adhesive applicator guns conventionally comprise trigger mechanisms which are utilized to actuate both a needle valve member of a needle valve assembly which controls the discharge or deposition of the hot melt adhesive material from the applicator gun nozzle assembly in accordance with a predetermined hot melt adhesive deposition pattern, as well as an electrical switch assembly which, in turn, is utilized to activate, for example, both an adhesive material rotary gear pump by means of which adhesive material is supplied under pressure to the applicator gun, and a solenoid air valve by means of which pressurized air can be supplied to the nozzle assembly of the applicator gun in a swirl application mode for interaction with the adhesive material being dispensed. As may best be appreciated from FIG. 1 which discloses, in effect, the handle portion of a hot melt adhesive applicator gun which may be similar to the applicator gun disclosed within the aforenoted patent application and which is generally indicated by the reference character 10, an applicator gun trigger member 12 is pivotally mounted by means of a pivot pin, not shown, upon an upper needle valve actuator housing 14, which is only partially shown. A handle housing 16 is integral with the needle valve actuator housing 14, and a trigger cover or trigger guard 18 also integrally interconnects the handle housing 16 and the needle valve actuator housing 14. A space 20 is therefore formed between the trigger guard or cover 18 and the trigger member 12 so as to permit an operator's fingers to be insert therewithin in order to accordingly actuate the trigger member 12 when a hot melt adhesive dispensing operation is to be performed.

An electrical connector 22, shown only partially, is fixedly mounted within a lower end portion of the handle housing 16 so as to provide electrical power from an external power source, not shown, to an electrical power cable 24 which is disposed internally within the handle housing 16. The electrical power cable 24 is operatively connected to a microswitch assembly or mechanism 26 which is provided for controlling electrical power to, for example, both an adhesive material rotary gear pump, not shown, by means of which adhesive material is supplied under pressure to the applicator gun 10, and a solenoid air valve, also not shown, by means of which pressurized air can be supplied to the nozzle assembly of the applicator gun 10 in a swirl application mode for interaction with the adhesive material being dispensed by the applicator gun 10. The microswitch assembly or mechanism 26 is mounted upon a mounting bracket 27 fixedly mounted within the interior portion of the handle housing 16, and has an external microswitch lever or finger 28 operatively connected thereto. It is further seen that the trigger member 12 is provided with a rearwardly extending cam member 30 wherein an upper surface portion thereof is normally disposed in contact with an undersurface portion of the microswitch lever or finger 28. Accordingly, when the trigger member 12 is actuated as a result of being depressed or squeezed by operator personnel, the cam member 30 will effectively force the microswitch lever or finger 28 upwardly so as to cause the microswitch assembly or mechanism to be switched from an OPEN state to a CLOSED state whereby the aforenoted rotary gear pump and solenoid air valve components will be activated or energized for respectively supplying the adhesive and swirl air.

In view of the fact that applicator guns are relatively compact in size, the microswitch assembly 26 itself is necessarily small and fragile. Periodically, the applicators are dismantled or disasembled for maintenance, repair, or the exchange of components, such as, for example, to exchange trigger members, or to change the orientation of the electrical connectors, the heater bodies, and the hanging brackets. Subsequently, of course, the applicators are re-assembled. Accordingly, it can be readily appreciated that when each applicator is opened or disassembled, the microswitch assembly 26 becomes exposed, which renders the microswitch lever or finger 28 particularly vulnerable in view of the relatively small thickness dimension of the microswitch lever or finger 28 as well as its cantilevered mounting upon the microswitch assembly 26, all of which render the microswitch lever or finger 28 flexible and easily deformable. Periodically, then, it has been experienced that the microswitch lever or finger 28 will be dislodged or moved away from its normal position as has been illustrated in FIG. 1 so as to be disposed or located at an abnormal position as illustrated in FIG. 2. It can therefore be further appreciated that in lieu of the cam member 30 of the trigger member 12 being disposed beneath the microswitch lever or finger 28 such that the upper surface portion thereof can normally engage the undersurface portion of the microswitch lever or finger 28 and therefore bias the microswitch lever or finger 28 upwardly, when the trigger member 12 is depressed or squeezed, so as to activate the microswitch assembly or mechanism 26 whereby the microswitch assembly or mechanism 26 will be switched from an OPEN state to a CLOSED state, an end portion of the cam member 30 will engage an end portion of the microswitch lever or finger 28. Accordingly, when the trigger member 12 is squeezed or depressed, the microswitch lever or finger 28 will not be properly actuated whereby, in turn, the microswitch lever or finger 28 will not activate the microswitch assembly 26 in accordance with the desired mode of operation.

A need therefore exists in the art for a new and improved non-contact switch system wherein the various elements comprising the non-contact switch system are rigidly mounted upon the handle housing and trigger member components of the applicator gun such that none of the elements comprising the non-contact switch system can be inadvertently bent, moved, or dislodged from their normal positions so as to render the non-contact switch system inoperable due, for example, to a relative misalignment of any of the non-contact switch system elements.

### OBJECTS OF THE INVENTION

Accordingly, it is an object of the present invention to provide a new and improved non-contact switch system for use within hot melt adhesive applicator guns.

Another object of the present invention is to provide a new and improved non-contact switch system for use within hot melt adhesive applicator guns wherein the non-contact switch system overcomes the various operational drawbacks and disadvantages of conventional PRIOR ART microswitch assemblies.

An additional object of the present invention is to provide a new and improved non-cpontact switch system for use within hot melt adhesive applicator guns wherein the various operative elements of the non-contact switch system are rigidly attached upon the handle and trigger components of the hot melt adhesive applicator gun.

A further object of the present invention is to provide a new and improved non-contact switch system for use within hot melt adhesive applicator guns wherein the various operative elements of the non-contact switch system are rigidly attached upon the handle and trigger components of the hot melt adhesive applicator gun so as to be incapable of being moved from their normal operative positions to undesirable abnormal inoperative positions thereby rendering the applicator gun inoperative when the trigger member is operatively depressed or squeezed.

A last object of the present invention is to provide a new and improved non-contact switch system for use within hot melt adhesive applicator guns wherein the various operative elements of the non-contact switch system are rigidly attached upon the handle and trigger components of the hot melt adhesive applicator gun and are not disposed in physical contact with each other so as not to be forcefully moved from their normal operative positions to undesirable abnormal inoperative positions thereby rendering the applicator gun inoperative when the trigger member is operatively depressed or squeezed.

### SUMMARY OF THE INVENTION

The foregoing and other objectives are achieved in accordance with the teachings and principles of the present invention through the provision of a new and improved non-contact switch system for use within a hot melt adhesive applicator gun wherein the non-contact switch system comprises various elements thereof rigidly mounted upon the handle housing and trigger member components of the hot melt adhesive applicator gun. In this manner, when the applicator gun is opened or disassembled for repair, maintenance, or component part interchange procedures or operations, damage or misalignment of the various elements of the non-contact switch system is effectively prevented. In particular, the non-contact switch system can comprise, for example, a magnetic reed switch system, a proximity switch system, an optical switch system, or the like. Accordingly, in view of the fact that one of the elements of the non-contact switch system is mounted upon, for example, the handle housing component of the applicator gun, while the other one of the elements of the non-contact switch system is mounted upon the trigger member component of the applicator gun, when the trigger member is actuated as a result of being depressed or squeezed, the elements of the non-contact switch system will operatively cooperate together so as to effectively move, switch, or change the non-contact switch mechanism from an OPENED state to a CLOSED state so as to be capable of controlling, for example, a rotary gear pump for supplying pressurized adhesive material to the applicator gun, as well as a solenoid air valve for supplying swirl air to the applicator gun for controlling the deposition pattern of the dispensed hot melt adhesive material.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1 is a partial, cross-sectional view of a conventional PRIOR ART hot melt adhesive applicator gun showing primarily the handle portion thereof within which there is disposed a microswitch assembly having its microswitch finger disposed in a normal operative position so as to be properly engaged by the applicator gun trigger member when the trigger member is depressed or squeezed;

FIG. 2 is a partial, cross-sectional view similar to that of FIG. 1 showing, however, the disposition of the conventional PRIOR ART microswitch finger of the microswitch assembly disposed at an abnormal inoperative position so as not to be properly engageable by the applicator gun trigger member;

FIG. 3 is a partial, cross-sectional view similar to that of FIGS. 1 and 2 showing, however, a first embodiment of a new and improved non-contact switch system wherein the non-contact switch system comprises a magnetic reed switch system having the reed switch mechanism and magnetic member elements respectively rigidly mounted upon the handle section and trigger member components of the applicator gun;

FIG. 4 is a partial, cross-sectional view similar to that of FIG. 3 showing, however, a second embodiment of a new and improved non-contact switch system wherein the non-contact switch system comprises a proximity switch system having the proximity switch mechanism and the metal actuator member elements respectively rigidly mounted upon the handle section and trigger member components of the applicator gun; and

FIG. 5 is a partial, cross-sectional view similar to that of FIGS. 3 and 4 showing, however, a third embodiment of a new and improved non-contact switch system wherein the non-contact switch system comprises an optical switch system having the photodetector and actuator member elements respectively rigidly mounted upon the handle section and trigger member components of the applicator gun.

### DETAILED DESCRIPTION OF THE PREFERRED EMBODIMENT

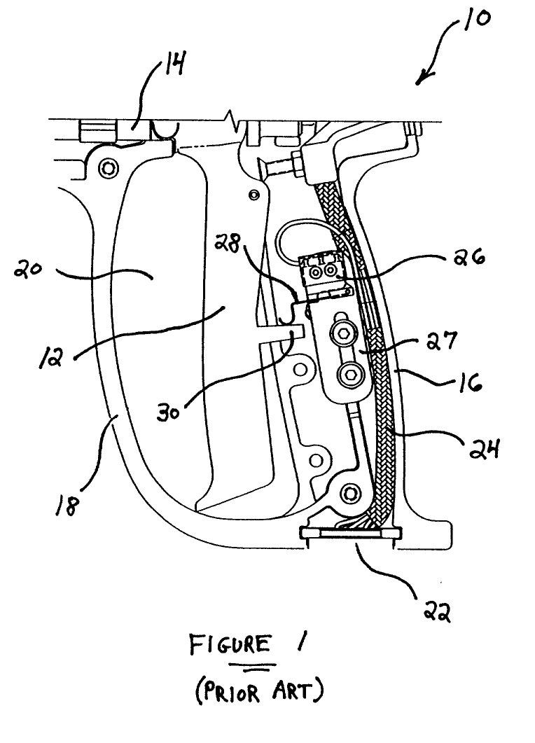

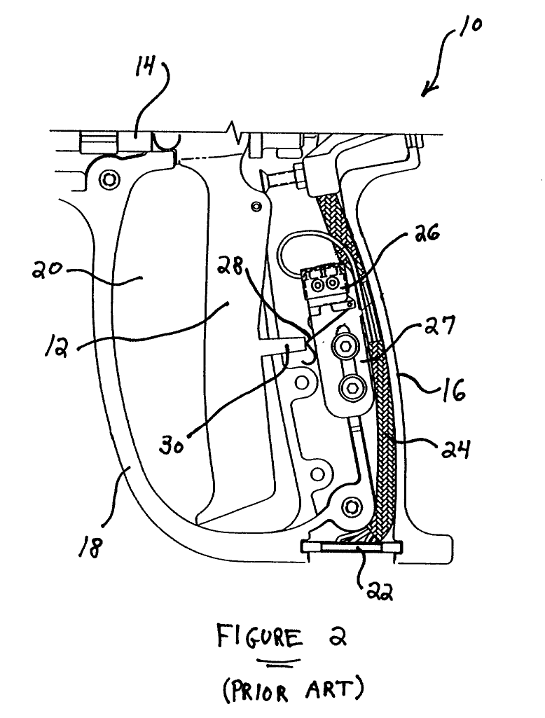

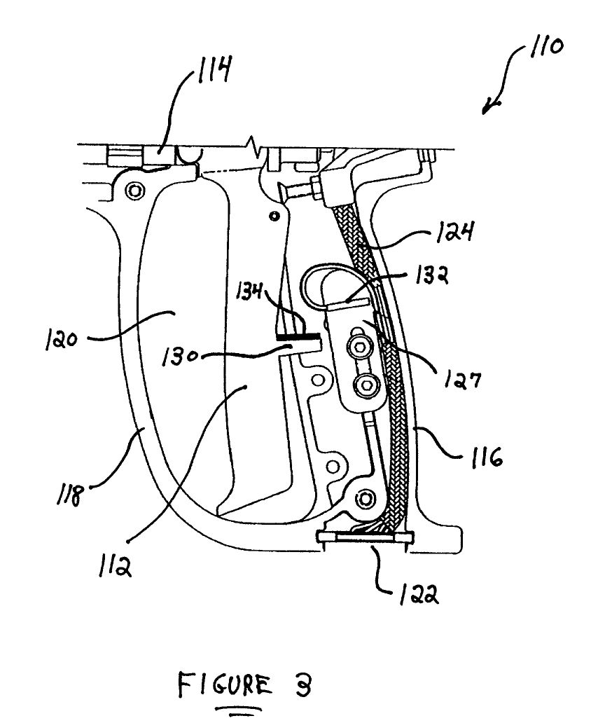

Referring now to the drawings, and more particularly to FIG. 3 thereof, a first embodiment of a new and improved non-contact switch system, constructed in accordance with the principles and teachings of the present invention, is disclosed and is generally indicated by the reference character 110. It is noted that the structural arrangement of the various components comprising the applicator gun as illustrated in FIG. 3 is quite similar to the arrangement of components comprising the applicator guns illustrated within FIGS. 1 and 2, and therefore a detailed description of the corresponding components will be omitted so as to concentrate the detailed description of this patent application upon those components which are different from those of the systems disclosed within FIGS. 1 and 2 and which therefore comprise the present invention. In addition, it is noted further that the corresponding components will be designated by corresponding reference characters, except that the reference characters will be within the 100 series. More particularly, as illustrated within FIG. 3, and in accordance with the principles and teachings of the present invention, the first embodiment of a new and improved non-contact switch system is disclosed and is generally indicated by the reference character 110. The applicator gun trigger member is disclosed at 112 and the applicator gun handle housing or section is disclosed at 116. A mounting bracket 127, similar to the mounting bracket 27, is fixedly mounted within the interior portion of the handle housing 116, however, in lieu of the microswitch assembly 26 being mounted upon the mounting bracket 27, a reed switch mechanism 132 is fixedly mounted upon the mounting bracket 127. Reed switches per se are of course well-known in the art, and therefore, a detailed description of the same will be omitted herefrom in the interest of brevity. Briefly, however, it is understood that a reed switch basically comprises two reed members which are normally spaced apart from each other so as to define an OPENED state for the switch mechanism. When, however, a magnetic member or magnet is moved into the vicinity or region of the reed switch mechanism, the magnetic field of the magnetic member or magnet will effectively interact with one of the reed members of the reed switch mechanism so as to cause such reed member to move toward and into contact with the other reed member thereby changing the status of the reed switch mechanism from its OPENED state to a CLOSED state.

In accordance with the principles and teachings of the first embodiment of the present invention, it is therefore seen that a magnet or similar magnetic member 134 is fixedly mounted upon the rearwardly projecting member or finger 130 of the trigger member 112. In addition, it is noted that the reed switch mechanism 132 is mounted upon the mounting bracket 127 at a predetermined elevational level such that when the trigger member 112 is actuated as a result of being depressed or squeezed, whereby the rearwardly projecting member or finger 130 will be correspondingly moved rearwardly or toward the right as viewed in FIG. 3, then the magnetic member or magnet 134 fixedly mounted upon the trigger member finger 130 will be disposed within a predetermined or pre-defined vicinity or region of the reed switch mechanism 132 so as to activate the switch mechanism 132 and thereby change the state of the switch mechanism 132 from OPENED to CLOSED. Obviously, when the operator personnel releases the trigger member 112, the trigger member 112 will be returned to its normal, non-depressed or non-squeezed state at which the magnetic member or magnet 134 has been effectively removed and is disposed remote from the vicinity or region of the reed switch mechanism 132 whereby the reed switch mechanism 132 will again attain or be disposed in its OPENED state. In view of the fact that the reed switch mechanism 132 is rigidly mounted upon the mounting bracket 127, in view of the additional fact that the components of the reed switch mechanism 132 are effectively self-contained in that none of the operative components are externally exposed as is the case of the microswitch finger 28 of the microswitch mechanism 26, and in view of the still further fact that the magnetic member or magnet 134 does not actually physically engage or contact any operative element of the reed switch mechanism 132, none of the operative elements of the reed switch mechanism 132 are susceptible to inadvertent damage, bending or deformation forces, misalignment, or the like. Accordingly, the operative integrity of the switch system 110 remains intact despite repeated assembly or disassembly procedures or operations performed upon the applicator gun for the aforenoted repair, component exchange or re-orientation, or maintenance purposes.

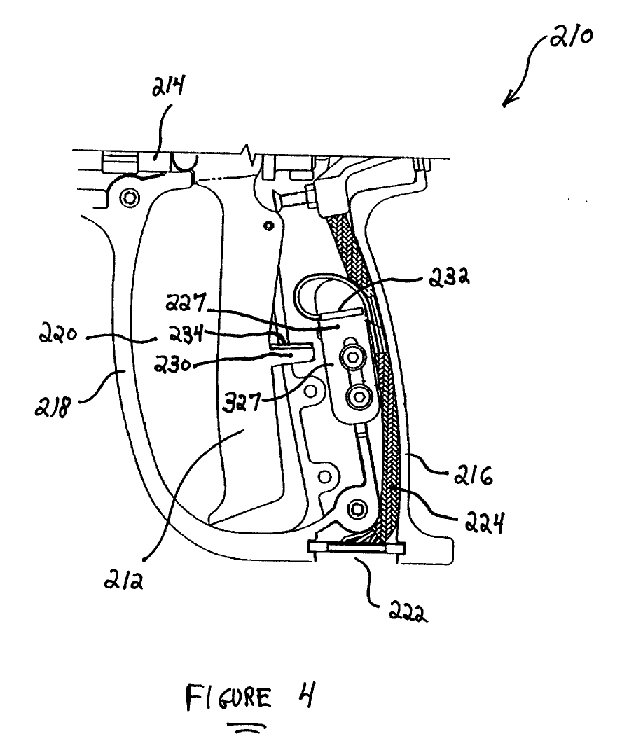

With reference now being made to FIG. 4, a second embodiment of a new and improved non-contact switch system, also constructed in accordance with the principles and teachings of the present invention, is disclosed and is generally indicated by the reference character 210. It is noted that the structural arrangement of the various components comprising the second embodiment applicator gun as illustrated within FIG. 4 is quite similar to the arrangement of components comprising the first embodiment applicator gun of the present invention as illustrated within FIG. 3, and therefore a detailed description of the corresponding components will be omitted herefrom so as to concentrate the detailed description of this patent application upon those components of the second embodiment system which are different from those of the first embodiment system as disclosed within FIG. 3. In addition, it is noted further that the corresponding components will be designated by corresponding reference characters, except that the reference characters will be within the 200 series.

More particularly, as illustrated within FIG. 4, and in accordance with the principles and teachings of the present invention, in lieu of the non-contact reed switch mechanism 132 of the first embodiment 110 of the present invention, a proximity switch mechanism 232 is fixedly mounted upon a corresponding mounting bracket 227. Proximity switches per se are of course well-known in the art, and therefore, a detailed description of the same will be omitted herefrom in the interest of brevity. Briefly, however, it is understood that a proximity switch basically comprises two magnetic members which are normally spaced apart from each other so as to define an OPENED state for the switch mechanism. When, however, a metal member is moved into the vicinity or region of the proximity switch mechanism, the metal member causes a concentration of flux within one of the magnetic members of the proximity switch mechanism so as to cause the other one of the magnetic members to move toward and into contact with the first magnetic member thereby changing the status of the reed switch mechanism from its OPENED state to a CLOSED state.

In accordance with the principles and teachings of the second embodiment of the present invention, it is therefore seen that a metal member 234 is fixedly mounted upon the rearwardly projecting member or finger 230 of the trigger member 212. In addition, it is noted that the proximity switch mechanism 232 is mounted upon the mounting bracket 227 at a predetermined elevational level such that when the trigger member 212 is actuated as a result of being depress ed or squeezed, whereby the rearwardly projecting member or finger 230 will be correspondingly moved rearwardly or toward the right as viewed in FIG. 4, then the metal member 234 fixedly mounted upon the trigger member finger 230 will be disposed within a predetermined or pre-defined vicinity or region of the proximity switch mechanism 232 so as to activate the switch mechanism 232 and thereby change the state of the switch mechanism 232 from OPENED to CLOSED. Obviously, when the operator personnel releases the trigger member 212, the trigger member 212 will be returned to its normal, non-depressed or non-squeezed state so as to effectively remove the metal member 234 from within the vicinity or region of the proximity switch mechanism 232 whereby the proximity switch mechanism 232 will again attain or be disposed in its OPENED state. In view of the fact that the proximity switch mechanism 232 is rigidly mounted upon the mounting bracket 227, in view of the additional fact that the components of the proximity switch mechanism 232 are effectively self-contained in that none of the operative components are externally exposed as is the case of the microswitch finger 28 of the microswitch mechanism 26, and in view of the still further fact that the metal member 234 does not actually physically engage or contact any operative element of the proximity switch mechanism 232, none of the operative elements of the proximity switch mechanism 232 are susceptible to inadvertent damage, bending or deformation forces, misalignment, or the like. Accordingly, the operative integrity of the switch system 210 remains intact despite repeated assembly or disassembly procedures or operations performed upon the applicator gun for the aforenoted repair, component exchange or re-orientation, or maintenance purposes.

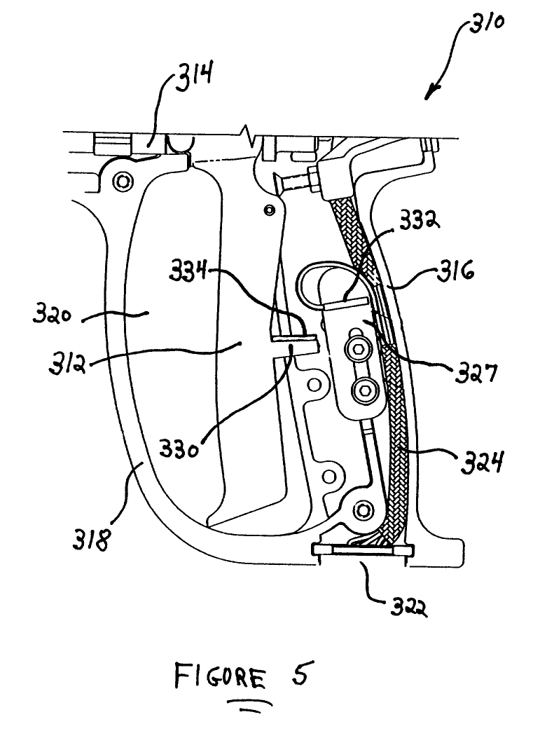

With reference lastly being made to FIG. 5, a third embodiment of a new and improved non-contact switch system, as constructed in accordance with the principles and teachings of the present invention, is disclosed and is generally indicated by the reference character 310. It is noted that the structural arrangement of the various components comprising the third embodiment applicator gun as illustrated within FIG. 5 is quite similar to the arrangement of components comprising the first and second embodiments of the applicator gun of the present invention as illustrated within FIGS. 3 and 4, and therefore a detailed description of the corresponding components will be omitted herefrom so as to concentrate the detailed description of this patent application upon those components of the third embodiment system which are different from those of the first and second embodiment systems as disclosed within FIGS. 3 and 4. In addition, it is noted further that the corresponding components will be designated by corresponding reference characters, except that the reference characters will be within the 300 series.

More particularly, as illustrated within FIG. 5, and in accordance with the principles and teachings of the present invention, in lieu of the non-contact reed switch mechanism 132 and the proximity switch mechanism 232 of the first and second embodiments 110, 210 of the present invenvention, an optical switch mechanism 332 is fixedly mounted upon a corresponding mounting bracket 327. Optical switches per se are of course well-known in the art, and therefore, a detailed description of the same will be omitted herefrom in the interest of brevity. Briefly, however, it is understood that an optical switch can comprise, for example, two components in the form of a phototransmitter and a photodetector. The switch can be such that an inactive or OPENED state of the switch is achieved when a light beam from the phototransmitter is continuously detected by the photodetector, however, when an actuator is interposed between the phototransmitter and photodetector so as to interrupt the transmission of the light beam from the phototransmitter to the photodetector, the switch is changed from its OPENED state to a CLOSED state. Alternatively, the switch can be such that an inactive or OPENED state of the switch is achieved when a light beam from the phototransmitter is not normally detected by the photodetector, however, when an actuator is disposed at a predetermined position so as to reflect the light beam from the phototransmitter back to the photodetector, the switch is changed from its OPENED state to a CLOSED state.

In accordance then with the principles and teachings of the third embodiment of the present invention, it is therefore seen that an actuator 334 is fixedly mounted upon the rearwardly projecting member or finger 330 of the trigger member 312. In addition, it is noted that the optical switch mechanism 332, which comprises the phototransmitter, is mounted upon the mounting bracket 327 at a predetermined elevational level such that when the trigger member 312 is actuated as a result of being depressed or squeezed, whereby the rearwardly projecting member or finger 330 will be correspondingly moved rearwardly or toward the right as viewed in FIG. 5, then the actuator 334 fixedly mounted upon the trigger member finger 330 will be disposed within the path of the emitted light beam from the phototransmitter of the optical switch mechanism 332. Accordingly, the actuator 334 can either interrupt the light beam being transmitted to a photodetector not shown but located, for example, within a lower portion of the handle housing 316, or reflect the light beam back to a photodetector not shown but also located within the optical switch mechanism 332 along with the phototransmitter. In either case, such movement of the actuator 334 activates the switch mechanism 332 so as to thereby change the state of the switch mechanism 332 from an OPENED state to a CLOSED state. Obviously, when the operator personnel releases the trigger member 312, the trigger member 312 will be returned to its normal, non-depressed or non-squeezed state so as to effectively remove the actuator 334 from its interruption position with respect to the optical switch mechanism 332 whereby the optical switch mechanism 332 will again attain or be disposed in its OPENED state. In view of the fact that the optical switch mechanism 332 is rigidly mounted upon the mounting bracket 327, in view of the additional fact that the components of the optical switch mechanism 332 are effectively self-contained in that none of the operative components are externally exposed as is the case of the microswitch finger 28 of the microswitch mechanism 26, and in view of the still further fact that the actuator 334 does not actually physically engage or contact any operative element of the optical switch mechanism 332, none of the operative elements of the optical switch mechanism 332 are susceptible to inadvertent damage, bending or deformation forces, misalignment, or the like. Accordingly, the operative integrity of the switch system 310 remains intact despite repeated assembly or disassembly procedures or operations performed upon the applicator gun for the aforenoted repair, component exchange or re-orientation, or maintenance purposes.

Thus, it may be seen that in accordance with the principles and teachings of the present invention, there has been disclosed several embodiments of a non-contact switch mechanism for use within a hot melt adhesive applicator gun wherein in view of the fact that the various operative components of the switch mechanism are rigidly mounted upon, for example, the trigger member and handle housing portion of the applicator gun, and that there is no physical contact between the operative components of the switch mechanism when the trigger member is actuated so as to activate the switch mechanism from its OPENED state to its CLOSED state, damage or deformation to the switch mechanism, or elements thereof, as has been experienced with PRIOR ART switch mechanisms, is effectively prevented.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters patent of the United States of America, is:

1. A non-contact switch mechanism for use within a fluid dispensing applicator gun having a handle housing and a trigger member pivotally mounted with respect to the handle housing, comprising:
a switch mechanism adapted to be rigidly mounted within the handle housing of the fluid dispensing applicator gun and characterized by an inoperative OPEN state and an operative CLOSED state; and
an actuator adapted to be rigidly mounted upon the trigger member of the fluid dispensing applicator gun so as to be disposed at a first position remote from said switch mechanism rigidly mounted within the handle housing of the fluid dispensing applicator gun such that said switch mechanism can attain said inoperative OPEN state when the trigger member is not actuated, and a second non-contact position within the vicinity of said switch mechanism rigidly mounted within the handle housing of the fluid dispensing applicator gun so as to cause said switch mechanism to attain said operative CLOSED state when the trigger member is actuated.

2. The non-contact switch mechanism as set forth in claim 1, wherein:
said switch mechanism comprises a reed switch mechanism; and
said actuator comprises a magnetic member.

3. The non-contact switch mechanism as set forth in claim 1, wherein:
said switch mechanism comprises a proximity switch mechanism; and
said actuator comprises a metallic member.

4. The non-contact switch mechanism as set forth in claim 1, wherein:
said switch mechanism comprises an optical switch mechanism comprising a phototransmitter and photodetector; and
said actuator comprises a member for interrupting a light beam from said phototransmitter to said photodetector.

5. The non-contact switch mechanism as set forth in claim 1, wherein:
said switch mechanism comprises an optical switch mechanism comprising a phototransmitter and photodetector; and
said actuator comprises a member for reflecting a light beam from said phototransmitter back to said photodetector.

6. A non-contact switch mechanism for use within a hot melt adhesive dispensing applicator gun having a handle housing and a trigger member pivotally mounted with respect to the handle housing, comprising:
a switch mechanism adapted to be rigidly mounted within the handle housing of the hot melt adhesive dispensing applicator gun and characterized by an inoperative OPEN state and an operative CLOSED state; and
an actuator adapted to be rigidly mounted upon the trigger member of the hot melt adhesive dispensing applicator gun so as to be disposed at a first position remote from said switch mechanism rigidly mounted within the handle housing of the hot melt adhesive dispensing applicator gun such that said switch mechanism can attain said inoperative OPEN state when the trigger member is not actuated, and a second non-contact position within the vicinity of said switch mechanism rigidly mounted within the handle housing of the hot melt adhesive dispensing applicator gun so as to cause said switch mechanism to attain said operative CLOSED state when the trigger member is actuated.

7. The non-contact switch mechanism as set forth in claim 6, wherein:
said switch mechanism comprises a reed switch mechanism; and
said actuator comprises a magnetic member.

8. The non-contact switch mechanism as set forth in claim 6, wherein:
said switch mechanism comprises a proximity switch mechanism; and
said actuator comprises a metallic member.

9. The non-contact switch mechanism as set forth in claim 6, wherein:
said switch mechanism comprises an optical switch mechanism comprising a phototransmitter and photodetector; and
said actuator comprises a member for interrupting a light beam from said phototransmitter to said photodetector.

10. The non-contact switch mechanism as set forth in claim 6, wherein:
said switch mechanism comprises an optical switch mechanism comprising a phototransmitter and photodetector; and
said actuator comprises a member for reflecting a light beam from said phototransmitter back to said photodetector.

11. A fluid dispensing applicator gun, comprising:
a handle housing;
a trigger member pivotally mounted with respect to said handle housing;
a switch mechanism rigidly mounted within said handle housing of said fluid dispensing applicator gun and characterized by an inoperative OPEN state and an operative CLOSED state; and
an actuator rigidly mounted upon said trigger member of said fluid dispensing applicator gun so as to be disposed at a first position remote from said switch mechanism rigidly mounted within said handle housing of said fluid dispensing applicator gun such that said switch mechanism can attain said inoperative OPEN state when said trigger member is not actuated, and a second non-contact position within the vicinity of said switch mechanism rigidly mounted within said handle housing of said fluid dispensing applicator gun so as to cause said switch mechanism to attain said operative CLOSED state when said trigger member is actuated.

12. The applicator gun as set forth in claim 11, wherein:
said switch mechanism comprises a reed switch mechanism; and
said actuator comprises a magnetic member.

13. The applicator gun as set forth in claim 11, wherein:
said switch mechanism comprises a proximity switch mechanism; and
said actuator comprises a metallic member.

14. The applicator gun as set forth in claim 11, wherein:
said switch mechanism comprises an optical switch mechanism comprising a phototransmitter and photodetector; and
said actuator comprises a member for interrupting a light beam from said phototransmitter to said photodetector.

15. The applicator gun as set forth in claim 11, wherein:
said switch mechanism comprises an optical switch mechanism comprising a phototransmitter and photodetector; and
said actuator comprises a member for reflecting a light beam from said phototransmitter back to said photodetector.

16. A hot melt adhesive material dispensing applicator gun, comprising:
a handle housing;
a trigger member pivotally mounted with respect to said handle housing;
a switch mechanism rigidly mounted within said handle housing of said fluid dispensing applicator gun and characterized by an inoperative OPEN state and an operative CLOSED state; and
an actuator rigidly mounted upon said trigger member of said fluid dispensing applicator gun so as to be disposed at a first position remote from said switch mechanism rigidly mounted within said handle housing of said fluid dispensing applicator gun such that said switch mechanism can attain said inoperative OPEN state when said trigger member is not actuated, and a second non-contact position within the vicinity of said switch mechanism rigidly mounted within said handle housing of said fluid dispensing applicator gun so as to cause said switch mechanism to attain said operative CLOSED state when said trigger member is actuated.

17. The applicator gun as set forth in claim 16, wherein:
said switch mechanism comprises a reed switch mechanism; and
said actuator comprises a magnetic member.

18. The applicator gun as set forth in claim 16, wherein:
said switch mechanism comprises a proximity switch mechanism; and
said actuator comprises a metallic member.

19. The applicator gun as set forth in claim 16, wherein:
said switch mechanism comprises an optical switch mechanism comprising a phototransmitter and photodetector; and
said actuator comprises a member for interrupting a light beam from said phototransmitter to said photodetector.

20. The applicator gun as set forth in claim 16, wherein:
said switch mechanism comprises an optical switch mechanism comprising a phototransmitter and photodetector; and
said actuator comprises a member for reflecting a light beam from said phototransmitter back to said photodetector.
